(19) United States
(12) Patent Application Publication
(10) Pub. No.: US 2020/0234372 A1
(43) Pub. Date: Jul. 23, 2020

(54) System and Method For Automated Investment

(71) Applicant: Interest Investments, Inc., Tampa, FL (US)

(72) Inventors: Robert Starr, Tampa, FL (US); Aaron Froug, Tampa, FL (US); Robin Froug, Tampa, FL (US)

(21) Appl. No.: 16/748,445

(22) Filed: Jan. 21, 2020

Related U.S. Application Data
(60) Provisional application No. 62/794,253, filed on Jan. 18, 2019.

(51) Int. Cl. G06Q 40/06; G06Q 40/02; G06Q 20/10; G06Q 30/02

(52) U.S. Cl. CPC G06Q 40/06; G06Q 30/0224; G06Q 20/10; G06Q 40/02

(57) ABSTRACT

The inventive system and method presented herein provides for the automated investment in financial instruments based on a user's shopping patterns or transaction history. Embodiments of the invention allow for the purchase of fractional shares or whole shares based on user selected preferences. The automated investment in financial instruments is accomplished through calculating an investment amount which may be a user defined amount, a round up to the nearest whole dollar, or a system required amount. The inventive system and method reviews a user's purchase transactions by monitoring spending on connected financial accounts of user (bank card, credit card, etc), extracting retailer data from the user's transactions, matching the retailer to one or more available security and purchasing an amount of the available security with the calculated investment amount. Thus the present invention allows for the automated investment and savings for its users, satisfying an unmet need.

### CROSS-REFERENCE TO RELATED APPLICATIONS

This application claims the benefit of U.S. Provisional Application No. 62/794,253, having a filing date of Jan. 18, 2019, the disclosure of which is hereby incorporated by reference in its entirety and all commonly owned.

### FIELD OF THE INVENTION

The present invention relates to systems and methods for automating investments, and more particularly to systems and methods for automated investments based upon a consumer's spending patterns and/or particular transactions.

### BACKGROUND OF THE INVENTION

Financial investment is a necessity for any financial portfolio, including, without limit, a retirement portfolio. In fact, it is recommended by most financial planners that people start investing for retirement as early as possible to maximize a retirement portfolio. One example shows that a person who invests $2000 per year at age 18, for 8 years, with no further investment through the remainder of their working career, will have more money saved for retirement age 65 than a person who invests $2000 per year from age 27 through age 65. Thus individuals need to be better engaged at investing, and the earlier the engagement the better.

Notwithstanding the importance of early retirement planning, many consumers feel that saving money is difficult. Those who make less than the median income level, or are raising families, find it particularly challenging to find money to invest. In addition, young people, particularly people under the age of thirty (30), struggle to manage their money. Many are for the first time experiencing the real-world financially on their own and tend to focus their spending habits on immediate gratification instead of long-term financial security. As a result of the foregoing, many people find themselves in their forties (40's) and being deficient in their financial needs for their impending retirement.

There have emerged several reasons that the aforementioned individuals do not take advantage of investing. A first reason many individuals have problems being engaged in investing, is that they don't believe they have enough money to save or invest. It is appreciated in this sense that many financial planners advise for investments in large amounts, and do not encourage small amounts, which in the aggregate, could eventually be a sizable investment. Thus there remains an unmet need that automates and allows for round-ups of financial transactions and depositing those round-ups in an investment vehicle.

A second reason many individuals have problems being engaged in investing, is that the purchase of stocks is believed to be complicated and lack the interest in doing the research and education. Particularly many simply don't know who to ask, what to invest in or how much they should invest. Thus there remains an unmet need to assist and automate investments for individuals to help them engage in adopting early investments for retirement and financial stability.

A third reason many individuals have problems being engaged in investing, is that even where they may have small amounts to invest, and they know what they may want to invest in, some stocks have purchase prices in excess of the small amounts they have to invest. Thus there remains an unmet need that allows for the purchase of all or portions of stocks customized to the available investment amount.

A fourth reason, that even where certain individuals are aware of fractional share investing, that is the purchase of a portion of a share of security, current methods require payment of commission fees and costs which may be far in excess of the value of the fractional share. The purchase price of a full share creates a barrier to entry for many investors who cannot afford to do so.

There have been some attempts at addressing some of the issues presented above, however, all offered solutions fall short of any substantial benefit of engaging users and solving the unmet need in the industry. While these solutions implement some form of round-ups or some other form of automated savings method to help people save and invest money automatically, none provide for the investment needs of their clients. For example, the present solutions either 1) put the transferred funds into a savings account earning approximately 1%, 2) put the money in a diversified mix of exchange traded funds (ETFs), or 3) they follow Modern Portfolio Theory which most investors are not familiar with. Additionally, most people do not know what an ETF is, nor how to use an ETF to their advantage. Thus use of these ETF's doesn't help people understand how to invest, and thus has failed to engage users into the investment market. Also investment in an ETF does not reflect a user's interest nor give them pride of ownership in owning a portion of a company they enjoy using.

Based on the foregoing, there is a need for a system and method for automatically facilitating savings, automatically investing, and allowing for the investment and management of fractional investments.

### SUMMARY OF THE INVENTION

The present invention provides for a system and method for the automated investment in financial instruments based on a user's shopping patterns or transaction history. Some embodiments allow for the purchase of fractional shares or whole shares based on user selected preferences. Some embodiments fund the purchase of financial instruments using spare change roundup, or whole dollar increment round-ups. At least one embodiment of the present invention utilizes dollar-based investing, rather than share-based investing, which allows for portions of shares in a particular company to be purchased, instead of purchasing whole share increments. In addition, at least one embodiment of the present invention provides for automated funding and investing based on a user's purchase transaction history, by rounding up and investing the round-ups into fractional shares of the companies from which a particular transaction occurred, to the extent that the company is publicly traded or is an affiliate or subsidiary of a publicly traded company. In some embodiments, if the company is not publicly traded, the round-up goes into a cash holding account. Thus, the present invention provides for a system and method for automatically facilitating savings, automatically investing, and allowing for the investment and management of fractional investments, satisfying an unmet need in the industry.

### DESCRIPTION OF DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIG. 1 provides a block flow diagram of at least one embodiment of the inventive automated trade method.

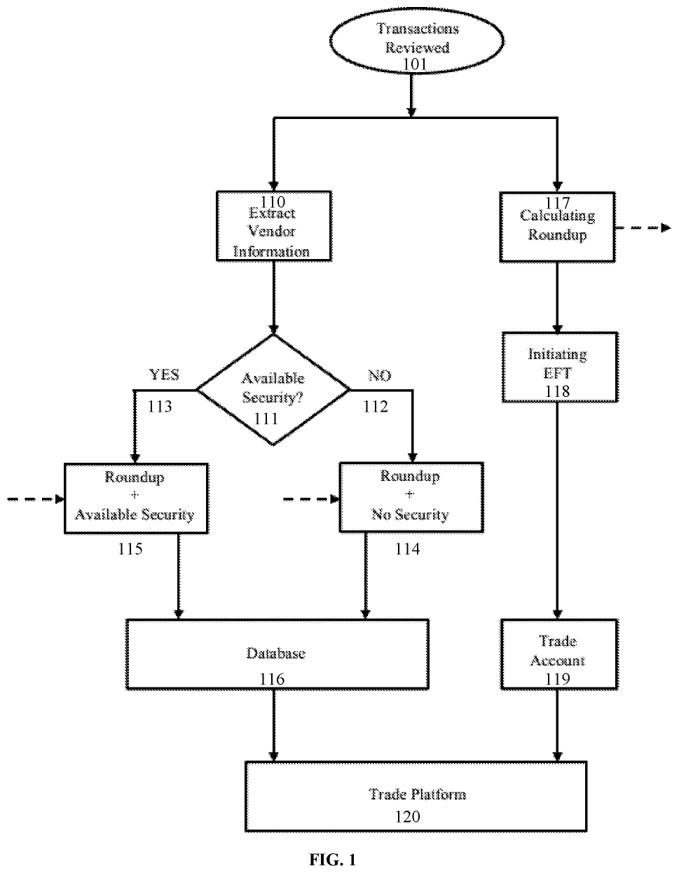

FIG. 2 provides a block flow diagram of at least one embodiment of the inventive automated trade method which includes a minimum trade protocol.

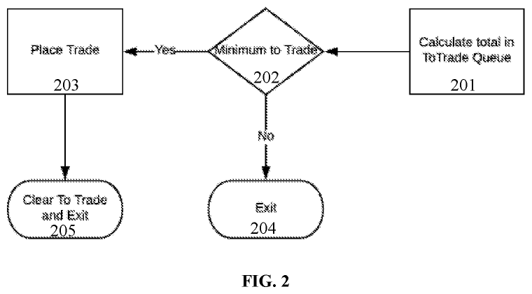

FIG. 3 provides a block flow diagram of at least one embodiment of the inventive automated trade method which includes a minimum trade protocol for aggregating trade transactions among a population of users.

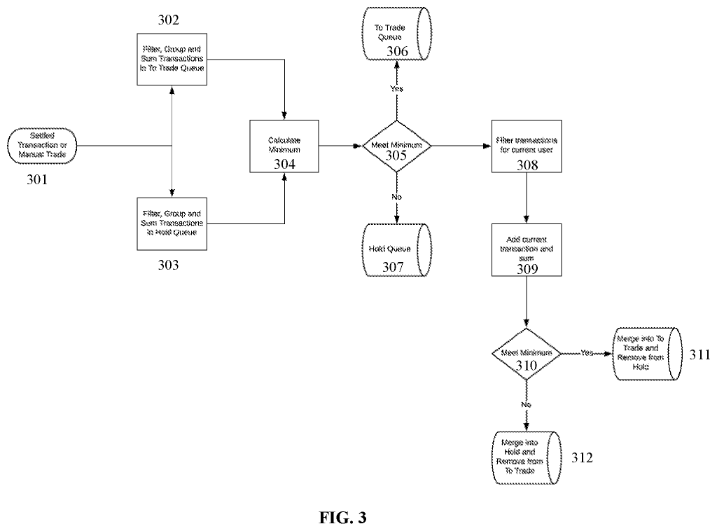

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

### DETAILED DESCRIPTION OF THE INVENTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Various terms used throughout the specification and claims are defined as set forth below as it may be helpful to an understanding of the invention.

As used herein a “software defined roundup rule” means one or more rules defined by the software or system for the roundup of transactions, including, without limit, indicating a particular amount to electronically transfer upon the occurrence of one or more transactions.

As used herein a “user computing device” means any computing device including, without limit, a laptop, a desktop, a smart phone, a tablet, a server, or combinations thereof.

As used herein a “user connected account” means one or more financial accounts of a user which a user selects and provides information such that transactions may be monitored, where such financial accounts include, but are not limited to, a bank account, credit card account, savings account, debit account, or other account with one or more financial institutions that can undergo one or more purchases of goods or services

As used herein “surrogate investment rule(s)” means one or more user-defined investment rules which would bypass the automatic method by purchasing a user-selected security in response to one or a series of particular transactions in lieu of the security associated with the transaction. A surrogate investment rule may further be one or more rules setup by a user for the purchase of one or more securities using round-up's that have been deposited into a cash holding account which are associated with a transaction where an available security could not be identified related to the transaction. A surrogate investment rule may further be a rule to not invest in a particular available security in response to a transaction.

As used herein “roundup value” means that difference between a transaction amount from a user connected account and the nearest whole dollar value greater than the transaction amount, or that difference between a transaction amount from a user connected account and the user-defined roundup rule, or depending on the user-defined roundup rule, the roundup value may be the user-defined roundup rule or whole dollar increments, or a software defined roundup rule.

As used herein “investment amount” means that amount withdrawn from a user selected account based on the calculated roundup value or other amount to be used for the purchase of one or more securities.

As used herein a “user-defined roundup rule” means one or more rules defined by a user for the roundup of transactions, including, without limit, indicating a particular amount to electronically transfer upon the occurrence of one or more transactions, indicating a different dollar amount greater than the transaction amount, or indicating to purchase a particular portion (or entire) of an available security associated with the transaction or a surrogate investment rule.

As used herein a “cash holding account” means one or more accounts to which roundup values or an investment amount is transferred by electronic funds transfer from a user-connected account for which available securities may be purchased from or an account in which cash is saved.

As used herein a “user-selected trade” is a manual trade made by a user, and more particularly, one or more investment selections designated by a user for an available security that is available to be purchased by use of the system or method.

The present invention contains the features of systems and methods for automated investments based upon a consumer's spending patterns and/or particular transactions as herein described.

### GENERAL

A system for automated investment is provided which includes at least one server, at least one user computing device, and at least one communication network for enabling communication between the user computing device and the server. In embodiments of the invention, the user computing device is configured to communicate with the server using said communication network through a software interface between the server and the user communication device. In embodiments of the invention, the server implements a computer-usable medium having a sequence of instructions which, when executed by a processor of the server, causes the processor to execute a process that automates investments for a user.

The system allows for users to register their account and enter in their information related to one or more of their accounts in which they conduct their financial transactions, such as checking accounts, savings accounts or credit card accounts. The server stores each of the user connected account information and monitors the user connected account to provide information for use in the automated investment method. In addition, from the information reviewed while monitoring the user connected accounts, the server is able to extract certain transaction elements, including, without limit, the vendor information and the transaction amount. Certain embodiments of the invention use such transaction information for determining round up values, and available securities associated with the transactions, each as further described herein.

In some embodiments, the server includes other functions such as the ability to store certain user preferences such as overriding certain purchases, providing surrogate investment rules related to one or more particular transactions, allowing for a user to search a brand, trademark, product, character or other information related to movies, products, or services which may relate to a particular available security. Such features are additionally further described herein.

The server of the system further includes certain software, documentation and database of information for enabling the automated investment method. In some embodiments, the server can alternatively monitor, review, or extract transaction information from financial institutions related to a user connected account, or may download one or more transactions from the financial institution prior to review.

### Automated Investment Method

The automated investment method allows for the review of one or more transactions from a user connected account. In at least one embodiment certain information is extracted or intercepted for a particular transaction from the one or more financial institutions related to a user connected account, including, without limit, the information related to the vendor, company or store with which the user made a purchase, the transaction amount, date, or transaction type.

Certain embodiments use the transaction information to query a database of compiled company information relating the names of companies to the availability of an available security of the company, and in some embodiments their stock symbol or ticker. Some embodiments further identify other securities which may be connected to a particular company or vendor which arises from a transaction. Further, some embodiments additionally include searching for affiliates, parent companies, or subsidiaries related to a company or vendor of the transaction and the availability of an available security related to such affiliate, parent company, or subsidiary. In such embodiments, the method further includes associating one or more available securities with each transaction.

The transaction is further reviewed to determine a dollar amount to be invested. In at least one embodiment, the method provides for calculating an investment amount of each transaction based on the roundup value, or other amount, calculated for a given transaction. Methods for calculating the roundup value and investment amount are described in further detail herein.

Based on the calculated roundup value, one or more electronic funds-transfers for each transaction in the amount of the calculated investment amount may be initiated. It is appreciated that other amounts, or set amounts by a user, may be substituted for the roundup value for the calculation of the investment amount. It is appreciated that because user accounts may encounter multiple transactions over a particular time period, which separate electronic funds-transfers may not be efficient or economical. Thus, in certain embodiments, where multiple transactions occur related to a user connected account over a particular time period, the electronic funds-transfers for all transactions are aggregated into a single electronic funds-transfer from the particular financial institution. In at least one embodiment where such transactions are aggregated, the individual transaction information is first stored, and then the funds received are disaggregated to the associated roundup value and/or investment amount associated with each transaction associated with each transaction.

In at least one embodiment, after receipt of funds from the one or more electronic funds-transfers, such funds are invested in an available security according to a particular transaction and its related roundup value or investment amount. Some embodiments allow for user selected preferences to invest more or less than the roundup value or investment amount in an available security. In some embodiments, where an available security cannot be associated with a transaction, the received funds from the one or more electronic funds-transfers may be stored in a cash holding account for a user to select investments at a later time, or to invest based on user selected preferences or a surrogate investment rule. In addition, in some embodiments, where an available security cannot be associated with a transaction, no electronic funds-transfer will be associated with such particular transaction.

### Round Up Methods

It is appreciated that the roundup value may be calculated in various ways, and nothing herein is intended to limit the way in which a roundup value is calculated. In at least one embodiment, the roundup value is calculated by rounding up a transaction amount to a rounded value and then subtracting the transaction amount of each transaction from the rounded value. In some embodiments, the rounded value is the nearest whole dollar value in excess of the transaction value. In other embodiments the roundup value are whole dollar increments.

In at least one embodiment, a user may select a cap for the roundup value such that no more than the user-defined rounded value cap is transferred for a particular transaction. Further, in at least one embodiment, an aggregation cap may be set, such that when roundup values are aggregated for the purpose of making a single electronic-fund transfers, that the aggregated transfer will not exceed a certain dollar value. In at least one embodiment, a roundup value, or aggregated round up value, may not be transferred via electronics fund transfer based on the available balance of an account. It is appreciated that such transfer exclusion may further be set by a financial institution, a pre-defined dollar value in the method, or a user pre-defined value.

### Instant Funding Method

In at least one embodiment, a roundup value and available security related to a transaction is reconciled at the point of transaction. In such embodiments, a user selected account is available to provide transaction information in real-time. By way of non-limiting example, upon a user transaction occurring at a merchant (i.e. a credit card is swiped, etc.), the transaction information is immediately reported to the system (e.g. the server). A roundup value is initiated based on the transaction value and an available security is associated with the roundup value. In at least one embodiment of this example, an amount from the user's cash holding account that is the same as the roundup value or investment amount, if available, is used to purchase the associated security prior to the electronic funds transfer of the roundup value or investment amount from the user connected account.

### Investment Methods and Database Query

It is appreciated that one benefit of the present invention is the automation of diverse investment based on a user's own spending patterns and habits. Without being bound to any particular theory, Modern Portfolio theory proposes mainly that investments should be diversified. It is believed that the more a user spends at different locations which have a corresponding publicly traded security to invest in along with cash being saved in an account this can create an automated diversified portfolio.

In at least one embodiment, where using the transaction information is used for associating one or more available securities with each transaction, the system or method must first identify a text feature from the one or more reviewed transactions at a particular financial institution. This text feature is transcribed into usable form by comparing the text feature, or a portion thereof, to a database of publicly traded companies. Through this comparison, it can be determined whether a vendor or company related to a particular transaction is publicly traded company associated with the transaction. This information is associated with the transaction and the corresponding roundup value. In at least one embodiment a database is created matching vendor information to available securities.

However, it is appreciated for one reason or another that a user may define surrogate investment rules for various reasons. Particularly, it is appreciated that certain transactions may not be able to be linked back to an available security. As provided for above, in at least one embodiment the roundup value may be subject to certain user-defined preferences which would either ignore the roundup value associated with the transaction, invest the roundup value in another available security, deposit the funds transferred associated with the roundup value in a cash holding account for user-selected trades or for purposes of saving cash. Additionally, it should be appreciated that where a certain transaction occurs, the transaction may not be recognizing the spending behavior of a user by identifying the products that it is actually purchasing. For example, a user may shop at a big box store or at a supermarket and predominantly buy one or more brands of foods. Using the transaction information, alone in this case, would not accurately reflect the spending patterns of the user. Thus allowing for surrogate investment rules, a user may identify one or more brands that it typically purchases and associate it with certain transactions, thus allowing for all or a portion of the roundup value or investment amount associated with a transaction to be invested toward the particular brands selected by the user. In at least one embodiment, the surrogate investment rules are customizable for each transaction. Allowing for these alternatives allows for additional diversification, education and engagement between a user and the present invention.

To support the foregoing, it is appreciated that in order to engage a user to use surrogate investing rules, or to allow a user to engage in one or more user-selected trades based on a cash holding account balance associated with a user's account, that providing investment related information at a user's fingertips is key to engaging a user. It is further appreciated that the structure of companies may be diverse, such that immediate identification of an available security may be difficult. Thus in at least one embodiment a user is able to search the database of available securities by using certain search terms such as but not limited to affiliates, subsidiaries, trademarks, characters, spokespersons, likeness, product specifications, product uses, QR Code, UPC code, or bar codes. Use of this search tool allows for the reporting of an associated available security to the user-specific search term. For example, a user may enter in the name of a super hero character, and the search tool would report the parent company or holding company which is publicly traded that owns such rights to the character. The user may then setup a surrogate investment rule for a roundup value associated with a movie ticket purchase, or a toy purchase at a big box store, to be invested in the available security of the parent or holding company. In at least one embodiment, a user may initiate a user-selected trade based on the database of available securities by searching the database of available securities by using certain search terms such as but not limited to affiliates, subsidiaries, trademarks, characters, spokespersons, likeness, product specifications, product uses, QR Code, UPC code, or bar codes.

### Minimum Purchase/Incremental Purchase

Another feature of the present invention is to allow for a user to invest in investment increments that the user can afford, or in this case that can be purchased with the roundup values or investment amount. In most instances, the available security associated with a transaction will have values of several dollars per share. Aggregating several transactions for a particular user from the same location would be necessary to initiate the investment of roundups in a whole share based upon their spending patterns. Thus the present invention changes this by allowing for the purchase of a portion or fraction of a share that corresponds to the roundup value associated with a particular transaction. Thus, for example, instead of aggregating $5.00 to purchase an entire share of a particular stock, a roundup value of $0.50 would be used to purchase 1110^{th} of a share of such stock. It is appreciated that many fractional share investment methods are known in the art, and nothing herein is intended to limit the invention to a particular method.

It is appreciated that in some embodiments there may be some limitations on an incremental value of a share purchase based. Such limitation may be a minimum portion, percentage or value, or a maximum portion, percentage or value. For example, a fractional trade platform may require a minimum share increment of 0.00001, or $0.15 on the day that an available security is $1,500.00. As a result, in at least one embodiment a roundup value associated with a particular transaction and available security may be stored in a cash holding account until an amount of roundups associated with a particular available security are available in a cash holding account to purchase the proscribed minimum portion, percentage or value. In some embodiments, an instruction to use other amounts available in a cash holding account not associated with a particular transaction with roundup value and associated available security are made in order to complete the proscribed minimum portion, percentage or value of an available security.

In some embodiments the roundup values associated with a particular associated security may be aggregated to a particular user, a particular set of users, or across the entire user population in order to meet the minimum portion, percentage or value of an available security.

In at least one embodiment where a minimum portion, percentage or value is implemented into the inventive system and method, the minimum transaction needed to purchase the minimum allowable amount of an available security is first selected. Account information of a population of users is reviewed and aggregated until the sum of transactions associated with a particular security meets the prescribed minimum portion, percentage or value of an available security. In at least one embodiment, the foregoing is accomplished by first filtering the cash holding accounts of a plurality of users for previous transactions and sums which individually or in the aggregate do not meet the minimum threshold. The filtered transactions are moved from the cash holding account to a “Hold” queue, including the transaction of a particular user. In this case, the amounts remain each individual user's cash holding account subject to their own surrogate investment rules and user defined investments. Upon the filtered transactions reaching the prescribed minimum portion, percentage or value of an available security, the cash holding accounts having a value associated with an available security are charged for transactions amount and the prescribed minimum portion, percentage or value of an available security is purchased. Each of the user's accounts is credited for that portion of the available security that their associated roundup values attributed.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

An automated investment method is implemented. The method is implemented through a software means. A user account is created and connected to a checking account and credit card account of a user. The transactions from the checking account and credit card account are reviewed by the software method, and the vendor information is analyzed to associate an available security with each transaction reviewed. In addition, the software method calculates a roundup value for each transaction. For this example, two transactions are reviewed, and no surrogate investment rule or user-defined round-up is provided. The first transaction is for $3.22 at Starbucks, the second transaction is for $48.54 at Walmart. The software method associates the publicly traded SBUX security on a stock exchange with a roundup value of $0.78, while the method associates the publicly traded WMT security on a stock exchange with a roundup value of $0.46. The software method initiates an electronic funds-transfer from the respective account of the reviewed transaction in the amount of the roundup value. The electronic funds-transfers are placed in the user's cash holding account along with the associated information related to the available security. In this instance a share of SBUX stock is worth $63.48 while a share of WMT stock is $93.04. The software method initiates the purchase of 0.0122 shares of SBUX stock and 0.0049 shares of WMT for the user, thus the user now owns fractional shares of Starbucks and Walmart based on their spending behaviors.

### Example 2

The software method of Example 1 is provided with the same user and the same transactions. For this example, two transactions are reviewed, and no surrogate investment rule or user-defined round-up is provided. The software method associates the publicly traded SBUX security on the stock exchange with a roundup value of $0.78, while the method associates the publicly traded WMT security on the stock exchange with a roundup value of $0.46. The software method initiates an electronic funds-transfer from the respective account of the reviewed transaction in the amount of the roundup value. The electronic funds-transfers are placed in the user's cash holding account along with the associated information related to the available security. In this instance a share of SBUX stock is worth $63.48 while a share of WMT stock is $93.04. The software method continues to aggregate roundup values for ongoing transactions associated with SBUX until the user's cash holding account includes roundups associated with SBUX in the amount of $63.48. Upon the $63.48 in roundups associated with SBUX transactions being available in the user's cash holding account, a share of SBUX is purchased, thus the user now owns a whole share of Starbucks. Likewise, the software method continues to aggregate roundup values for ongoing transactions associated with WMT until the user's cash holding account includes roundups associated with WMT in the amount of $93.04. Upon the $93.04 in roundups associated with WMT transactions being available in the user's cash holding account, a share of WMT is purchased, thus the user now owns a whole share of Walmart.

### Example 3

The software method of Example 1 is provided with the same user and the same transactions. For this example, the user has selected a surrogate investment rule such that each time they shop at Walmart, that the roundup value be invested in Mattel. The software method still associates the publicly traded SBUX security on the stock exchange with a roundup value of $0.78, but as a result of the surrogate investment rule, instead of investing in WMT, the method associates the publicly traded MAT security on the stock exchange with a roundup value of $0.46. In this instance a share of SBUX stock is worth $63.48 while a share of MAT stock is $9.94. The software method initiates the purchase of 0.0122 shares of SBUX stock and 0.0462 shares of MAT for the user, thus the user now owns fractional shares of Starbucks and Mattel based on their spending behaviors and surrogate investment rules.

### Example 4

The software method of Example 1 is provided with the same user and the same transactions. For this example, the user has selected a user-defined round-up such that each time they shop at Starbucks, that the roundup value is increased by an additional dollar. The software method associates the publicly traded SBUX security on the stock exchange with a roundup value of $1.78 to account for the user-defined round-up, while the method associates the publicly traded WMT security on the stock exchange with a roundup value of $0.46. In this instance a share of SBUX stock is worth $63.48 while a share of WMT stock is $93.04. The software method initiates the purchase of 0.0280 shares of SBUX stock and 0.0049 shares of WMT for the user, thus the user now owns fractional shares of Starbucks and Walmart based on their spending behaviors and user-defined round-up rules.

### Example 5

The software method of Example 1 is provided with the same user and the same transactions. For this example, the user has selected a user-defined round-up such that each time they shop, that the roundup value is increased by an additional dollar and allocated proportionately pro rata or other proportionate method among both transactions. In this case we use pro rata based upon stock price. The software method associates the publicly traded SBUX security on the stock exchange with a roundup value of $1.18 to account for the user-defined round-up, while the method associates the publicly traded WMT security on the stock exchange with a roundup value of $1.06. In this instance a share of SBUX stock is worth $63.48 while a share of WMT stock is $93.04. The software method initiates the purchase of 0.0185 shares of SBUX stock and 0.0114 shares of WMT for the user, thus the user now owns fractional shares of Starbucks and Walmart based on their spending behaviors and user-defined round-up rules.

### Example 6

A system for automated investment for a user is provided. The system includes a server, a communication network for enabling communication between a user computing device and the server as well as for enabling communication between the server and one or more user accounts. The user computing device is configured to communicate with the server. The server has implemented a computer-usable medium having a sequence of instructions which, when executed by a processor of the server, causes the processor to execute a process that automates investments for a user. The user has connected their checking account to the system, and the server monitors the user's checking account for posted transactions. The system allows for both automated and user-selected trades. The system is further setup to roundup transactions that cannot be associated with an available security.

The system reviews the transactions from the checking account and the vendor information is analyzed to associate an available security with each transaction reviewed. In addition, the software method implemented on the server calculates a roundup value for each transaction. For this example, several transactions are reviewed, but only one transaction is able to be associated with an available security. The transaction is for $3.22 at Starbucks. The software method associates the publicly traded SBUX security on a stock exchange with a roundup value of $0.78. The software method initiates an electronic funds-transfer from the user's checking account of the reviewed transaction in the amount of the roundup value. The electronic funds-transfer is placed in the user's cash holding account along with the associated information related to the available security. In this instance a share of SBUX stock is worth $63.48. The software method initiates the purchase of 0.0122 shares of SBUX stock, thus the user now owns a fractional share of Starbucks based on their spending behavior.

The remaining transaction where an available security could not be identified, a round-up value is associated with the transaction and transferred to the user's cash holding account for user-selected trade trading or kept there in cash to save. The transaction is for $5.54 at a local pastry shop. The software method does not associate any security with the transaction, but includes a roundup value of $0.46. The software method initiates an electronic funds-transfer from the user's checking account of the reviewed transaction in the amount of the roundup value. The electronic funds-transfer is placed in the user's cash holding account and made available for user-selected trade trades. The user initiates a user-selected trade to invest a portion of the cash holding account in Walmart. In this instance, the cash holding account balance is only $0.46, and the user selected to invest the entire $0.46 in Walmart. The software method associates the publicly traded WMT security on the stock exchange with a roundup value of $0.46 as a result of the user selected trade. In this instance a share of WMT stock is worth $93.04. The software method initiates the purchase of 0.0049 shares of WMT for the user, thus the user now owns a fractional share of Walmart based on their user-selected trade. Alternatively, the user can decide to keep the amount in cash.

### Example 7

The system of Example 6 implementing the software method of Example 1 is provided. In this instance a minimum transaction value is needed for a fractional share such that the minimum purchase is 1% of the value of the available security. In this instance a share of SBUX stock is worth $63.48, thus in order for the method to initiate a purchase a fractional share of Starbucks, $0.63 must be present in the user cash holding account. For the automated method, $0.63 must be present in the user's cash holding account and associated with a Starbucks purchase. The transaction is for $3.22 at Starbucks. The software method associates the publicly traded SBUX security on the stock exchange with a roundup value of $0.78. As a result 1% of a share of Starbucks is purchased for $0.63, and the remaining $0.15 associated with Starbuck remains in the User's cash holding account to be applied toward the purchase of a fractional share of SBUX upon future Starbucks transactions aggregating the cash holding account balance at or above the 1% threshold minimum and/or incremental purchase.

### Example 8

The system of Example 6 implementing the software method of Example 1 is provided. In this instance, the server communicates with third party software for receiving information regarding transaction information for a user's account. That information is implemented by the system to match an available security to the transaction along with the round-up value.

### OTHER EMBODIMENTS

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A method for automated investment, the method comprising:
initiating a computer automated review of one or more consumer or financial transactions from a user connected account;
extracting, through the use of a computer, information from the transaction relating to the amount of the transaction and the vendor with whom the transaction was initiated;
associating, through the use of a computer, one or more available securities related to the vendor of each transaction;
calculating, through the use of a computer, an investment amount of each transaction based on a calculated round up value;
initiating one or more electronic funds-transfers for each transaction in the amount of said investment amount, initiating a single electronic funds-transfer in the amount of an aggregate of investment amounts, or combinations thereof; and
electronically investing said investment amount in said one or more available securities related to the vendor of each transaction.

2. The method of claim 1 further comprising downloading said one or more transactions from said user connected account prior to said review.

3. The method of claim 1 wherein the electronic funds-transfers for one or more transactions for a user-connected account are aggregated into a single electronic funds-transfer then associated with each transaction and associated available security.

4. The method of claim 1 wherein said investment amount is calculated by rounding up the transaction amount to a rounded value and subtracting the transaction amount of each transaction from the rounded value.

5. The method of claim 1 whereby the investment amount of each transaction is calculated as a result of a roundup value set as a fixed value over a transaction as selected by a user, a fixed value selected by a computer, a percentage value of the transaction amount as selected by a user, a percentage value of the transaction amount selected by a computer, the difference between the transaction amount and the next highest whole dollar, or combinations thereof.

6. The method of claim 4 wherein said rounded value is the nearest whole dollar value in excess of the transaction value, or a user pre-defined value in excess of the transaction value.

7. The method of claim 1 wherein said one or more available securities associated with each transaction is based on the associated transaction information, or based on user pre-defined available security for one or more transactions.

8. The method of claim 1 further comprising investing said investment amount in a cash holding account to be invested based on a user pre-defined available security or to be held in cash if no available security can be associated with a transaction.

8. The method of claim 1 wherein said investment of said investment amount for a particular transaction is for the purchase of a whole, a portion, or a fractional interest of said available security based on the roundup value.

9. The method of claim 1 wherein said associating one or more available securities with each transaction further comprises:
identifying a text feature from said one or more reviewed transactions;
transcribing said text feature into usable form by comparing said feature to a database of publicly traded companies and identifying the publicly traded company associated with the transaction; and
reporting said publicly traded company associated with said transaction.

10. A system for automated investment, the system comprising:
a server;
a communication network for enabling communication between a user computing device and said server; and
a user computing device configured to communicate between said user computing device and said server using said communication network;
wherein said server implementing a computer-usable medium having a sequence of instructions which, when executed by a processor of the server, causes the processor to execute a process that automates investments for a user, the process comprising:
monitoring transactions from a user connected account;
associating one or more available securities with each transaction;
calculating an investment amount based on a roundup value calculated for each transaction;
initiating one or more electronic funds-transfers for each transaction in the amount of said investment amount; and
investing said investment amount for a particular transaction in said available security associated with said transaction.

11. The system of claim 10 wherein the process further comprises downloading said one or more transactions from said user connected account prior to said review.

12. The system of claim 10 wherein the electronic funds-transfers for one or more transactions for a user-connected account are aggregated into a single electronic funds-transfer then associated with each transaction and associated available security.

13. The system of claim 10 wherein said investment amount is calculated by rounding up the transaction amount to a rounded value and subtracting the transaction amount of each transaction from the rounded value.

14. The system of claim 13 wherein said rounded value is the nearest whole dollar value in excess of the transaction value, or a user pre-defined value in excess of the transaction value.

15. The system of claim 10 wherein said one or more available securities associated with each transaction is based on the associated transaction information, or based on user pre-defined available security for one or more transactions.

16. The system of claim 15 wherein if no available security can be associated with a transaction, investing said investment amount in a cash holding account to be invested based on a user pre-defined available security.

17. The system of claim 10 wherein said investment of said investment amount based on the roundup value for a particular transaction is for the purchase of a portion of said available security based on the investment amount.

18. The system of claim 10 wherein said associating one or more available securities with each transaction of the process further comprises:
identifying a text feature from said one or more reviewed transactions;
transcribing said text feature into usable form by comparing said feature to a database of publicly traded companies and identifying the publicly traded company associated with the transaction; and
reporting said publicly traded company associated with said transaction.

19. The system of claim 10, wherein said server communicates transaction amounts, inventory of share investments, and other information associated with a particular user account to said user communication device.

20. The system of claim 10, further comprising allowing a user to enter one or more terms to search, comparing the search term to the database of available securities and associated information, affiliates, subsidiaries, trademarks, characters, spokespersons, likeness, product specifications, product uses, UPC Codes, QR Codes, or bar codes, and returning an available security which relates to the search term.
